(19) United States
(12) Patent Application Publication
(10) Pub. No.: US 2006/0138043 A1
(43) Pub. Date: Jun. 29, 2006

(54) Process for preparation of thin film composite membrane

(76) Inventors: Ulhas Kanhaiyalal Kharul, Maharashtra (IN); Manojkumar Prakash Achalpurkar, Maharashtra (IN); Harshada Ramesh Lohokare, Maharashtra (IN)

Correspondence Address: OSTROLENK, FABER, GERB & SOFFEN, LLP, 1180 Avenue of the Americas, New York, NY, 10036-8403, US

(21) Appl. No.: 11/020,304

(22) Filed: Dec. 23, 2004

(51) Int. Cl. B05D 5/00; B05D 3/00; B05D 3/02; B05D 1/18

(52) U.S. Cl. 210/490; 210/500.27; 427/245; 427/384; 427/299; 427/434.6

(57) ABSTRACT

Thin Film Composite (TFC) membranes are prepared by coating a thin layer of aminated silicon rubber on the surface of highly porous substrate like ultrafiltration membrane, followed by crosslinking with reactive, aliphatic dialdehyde and curing at high temperature. The TFC membranes so prepared have amine functionality making them suitable for varied separation applications in gas separation, vapor permeation, pervaporation and other membrane separation processes.

### FIELD OF THE INVENTION

The present invention relates to an improved process for preparation of thin film composite membranes. More particularly the present invention relates to a process using aminated polysiloxanes as coating materials and use of, reactive and aliphatic dialdehyde as a crosslinker in interfacial manner.

### BACKGROUND OF THE INVENTION

Thin film composite membranes are generally used on larger scale separation applications since high flux without serious threat to the selectivity can be achieved. A family of aminated polysiloxane containing methyl, ethyl, propyl, phenyl, benzyl, etc.; bearing amine functionality on polymer backbone or on side chain can be used as potential membrane materials. A range of porous ultrafiltration type membranes can be used as support for making TFC membranes. The presence of amine functionality could be very crucial for separation of materials that can form temporary complex with amines due to its basic nature / capability of forming H-bonds. Such materials can have more solubility in the membrane material. If the crosslinking is done using a flexible aliphatic dialdehyde, such membranes could offer high fluxes. This could be crucial in some of the membrane-based applications such as recovery of aroma compounds or valuable organic compounds having specific functionalities by methods like gas separation, vapor permeation, pervaporation, or perstraction.

In the prior art, Hirose and Kurihara (JP 105203, 1982) demonstrated process for production of selectively permeable membranes by crosslinking amino polysiloxane with crosslinking agents such as acid chlorides, acid anhydrides, isocyanate, thiocyanate, sulfonyl chloride, epoxides, or compounds containing two or more functional groups such as active halogens in each molecule.

Cabasso and Arthur (EP 181772 A2, 1986) report manufacture of permselective membranes by in-situ crosslinking of amino siloxanes (1-9 mol % amino units) with diisocyanates on the surface of highly porous polymer substrates. The composite membranes as demonstrated here have O₂ permeability coefficient as 18×10⁻¹⁰ cm³. cm.sec⁻¹.cm⁻².(cmHg)⁻¹ to 180×10⁻¹⁰ cm³.cm.sec⁻¹ cm⁻² (cmHg)⁻¹ and for nitrogen 6×10⁻¹⁰cm³.cm. sec⁻¹(cmHg)⁻¹ to 75×10⁻¹⁰ cm³.cm.sec⁻¹.cm⁻² (cmHg)^{-1.}

Japanese Patent JP 59062305 A2 (1984) discloses gas separation membranes which comprises microporous polysulfone film , dipped in 1% bis(3-aminopropyl) tetramethyldisiloxane in EtOH/H₂O, drained for 10 minutes, then dipped in 1% MDI in hexane and dried to obtain a film with a permselective copolymer surface layer of ˜0.1μthick, which was then coated with a 50μlayer of a 5:15:80 nylon-CaC1₂-MeOH composition and immersed in water to gel the coating and extracting the CaC1₂ and MeOH, leaving a porous-protective layer ˜2μthick. The resulting composite membrane had O₂ permeation rate 0.7×10⁻⁵cm³/(cm².s.cmHg).

Masaru et al (JP 60175505 A2, 1985) report the membrane preparation by coating water-immiscible organic solvent solution containing 0.1% aminopolysiloxanes on porous supports, then coating with reactive cross linker solution containing polyfunctional reagents like trimesic chloride-I mixture, thus 1 part 0.5 NH₂-modified silicone oil (SF 8417) and 99 parts hexane were mixed and coated on a 210μ thick polysulfone support, dried for 30 min, coated with 3:97 trimesic chloride mixture, and dried for 8 minutes to give a composite membrane having an amide-crosslinked polysiloxane. layer, the membrane showed O2 permeation rate of 0.82 m³/m².h.atm.

Above literature reports various crosslinkers used for making aminated silicon rubber or polysiloxanes based TFC membranes, such as acid chlorides, acid anhydrides, isocyanate, thiocyanate, sulfonyl chloride, and epoxides. These crosslinkers are highly reactive and may impart rigidity to the otherwise flexible siloxanes linkages. The wide interest for silicon rubber based TFC membranes for membrane based separation processes like pervaporation, gas separation, vapor permeation, etc. is also due to highly flexible and permeable siloxane linkage and its organophilic nature.

None of the literature reports the use of aqueous solution of a flexible, aliphatic and reactive dialdehyde as the crosslinking agent to be reacted in an interfacial manner with organic solvent soluble aminated polysiloxanes to prepare thin film composite membranes. The dialdehydes like glutaraldehyde is aliphatic material and is flexible in nature owing to absence of rigidity imparting moieties like aromatic ring or vinyl bonds. Its reactivity being comparatively lower than the above demonstrated crosslinkers, its use may also offer better control on the crosslinking degree. These phenomenon results in more flexible structure of the skin layer of the membrane, which ultimately offers higher permeabilty of the formed TFC membrane. Another advantage of using aliphatic dialdehyde like glutaraldehyde as a crosslinker is that the solution of aminated polysiloxanes can be easily made in wide variety of nonaqueous solvents and can be used for coating on porous polymer supports like ultrafiltration membranes, which can then be crosslinked by aqueous solution of dialdehyde like glutaraldehyde in interfacial manner. This also helps in controlling the crosslinking of the skin layer by controlling the time of interfacial contact. Such TFC membranes still retains amine funtionality, which is sufficiently basic in nature. This can be used for selective transport of certain species in different membrane based separation processes such as pervaporation, vapour or gas permeation, etc.

### Objects of the Invention

The object of the present invention is to provide an improved process for preparation of thin film composite membranes based on aminated polysiloxanes using aqueous solution of aliphatic dialdehyde as a crosslinking agent in an interfacial manner, which obviates the drawbacks as detailed above.

### SUMMARY OF THE INVENTION

Accordingly, the present invention provides a process for preparation of a thin film composite membrane based on aminated polysiloxanes, the process comprising coating a pretreated porous support membrane with a solution of aminated polysiloxane in an organic water immiscible solvent, partially drying the coated membrane and crosslinking the partially dried coated membrane with an aqueous solution of aliphatic dialdehyde to obtain a crosslinked membrane, heating the crosslinked membrane in controlled manner to obtain the thin film composite membrane.

In one embodiment of the invention, the porous support membrane is prepared using polymer selected from the group consisting of polyacrylonitrile, polysulfone, polyethersulfones, polyetherimides, polyphenylene oxides, polyamides, polycarbonates, polyesters, polyethers, polyimides, polyamidimides and polyvinylidene fluoride, having capability of forming porous membrane with adequate porosity.

In another embodiment, the porous support membrane is pretreated by a conventional method i.e. dipping in solvents like alcohol, aliphatic or aromatic hydrocarbons, halogenated hydrocarbons or similar, either only once or sequentially in series of solvents for 10 seconds to 48 hours; or is dried by hot air flow or in an oven at 30° C. to 100° C.

In another embodiment, the aminated polysiloxane is selected from the group consisting of aminomethylpolysiloxane with amine value 5-90 mgKOH/gm, dimethyldiaminopolysiloxane -with amine value 5-90 mgKOH/gm, poly(dimethylsiloxane)bis[[3-[(2-aminoethyl)amino]propyl]-dimethylsilyl] ether, poly(dimethylsiloxane)-co-(3-aminopropyl)-methylsiloxane, poly(di methylsiloxane)-bis-(3-aminopropyl)terminated, N-(2-Aminoethyl)-3-aminopropylmethyldimethoxysilane, N-(2-Aminoethyl)-3-aminopropyltri methoxysilane, 3-aminopropylmethyl-di-ethoxysilane,3-aminopropyltri ethoxysilane, poly(dimethylsiloxane)-aminopropyl-dimethylterminated, aminofunctionalsiloxane copolymers containing aminomethyl, aminoethyl, aminopropylmethyl, aminobutyl; aminoethylaminopropylmethylsiloxane-di methylsiloxane copolymers, aminoethylaminoisobutylmethylsiloxane-di methylsiloxane copolymers, and aminoethylaminopropylmethoxysiloxane-di methylsiloxane copolymers.

In yet another embodiment, the aminated polysiloxane solution is prepared in a water immiscible solvent selected from the group consisting of chlorinated solvents, aromatic or aliphatic hydrocarbons and water saturated higher alcohols.

In another embodiment, the concentration of the aminated polysiloxane is in the range of 0.2% to 50%.

In another embodiment of the invention, the aminated polysiloxane coated membrane is heated at 30° C. to 100° C. for 10 seconds to 6 hours by either keeping in an oven or by drying with running hot air or by any other convenient method.

In another embodiment of the invention, the aminated polysiloxane coated on porous support membrane is crosslinked by dipping it into an aqueous dialdehyde solution for 2 seconds to 4 hours.

In another embodiment of the invention, the aliphatic dialdehyde has the following wtructure 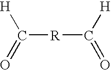
Where R=CₙHₘ; n=0-8; m=0-16

In another embodiment of the invention, the dialdehyde treated membrane is heated at 30° C. to 100° C. for 10 seconds to 6 hours by either keeping in an oven or by drying with running hot air or by any other convenient method.

In another embodiment of the invention, the concentration of aqueous dialdehyde solution used for crosslinking in interfacial manner is in the range of 0.1% v/v to 25% v/v.

In a feature of the present invention, thin film composite membranes are prepared by coating aminated polysiloxanes solution in appropriate solvent by dip coating, spray coating or any other method on the surface of the porous support membrane.

In another feature, the porous support membrane is in the form of flat sheet, tubular or hollow fiber.

In another feature, the flat sheet porous support membrane of varying porosity can be prepared on the top of woven or non-woven fabric by conventional methods.

In still another feature, the coating of aminated polysiloxane can be done on one side or on both sides of the porous support membrane or can be impregnated inside the pores.

### DETAILED DESCRIPTION OF THE INVENTION

The process of the invention provides a thin film composite membrane based on aminated polysiloxanes. The process comprises coating a pretreated porous support membrane with a solution of aminated polysiloxane in an organic water immiscible solvent by any conventional method. The coated layer is then partially dried and crosslinked with an aqueous solution of aliphatic dialdehyde. The crosslinked membrane obtained is heated in a controlled manner to obtain the thin film composite membrane.

The porous support membranes is prepared using polymer selected from the group consisting of polyacrylonitrile, polysulfone, polyethersulfones, polyetherimides, polyphenylene oxides, polyamides, polycarbonates, polyesters, polyethers, polyimides, polyamidimides and polyvinylidene fluoride, having capability of forming porous membrane with adequate porosity. The porous support membrane is pretreated by a conventional method i.e. dipping in solvents like alcohol, aliphatic or aromatic hydrocarbons, halogenated hydrocarbons or similar, either only once or sequentially in series of solvents for 10 seconds to 48 hours; or is dried by hot air flow or in an oven at 30° C. to 100° C.

The aminated polysiloxane is selected from the group consisting of aminomethylpolysiloxane with amine value 5-90 mgKOH/gm, dimethyldiaminopolysiloxane with amine value 5-90 mgKOH/gm, poly(dimethylsiloxane)bis[[3-[(2-aminoethyl)amino]propyl]-dimethylsilyl] ether, poly(dimethylsiloxane)-co-(3-aminopropyl)-methylsiloxane, poly(di methylsiloxane)-bis-(3-aminopropyl)terminated, N-(2-Aminoethyl)-3-aminopropylmethyldimethoxysilane, N-(2-Aminoethyl)-3-aminopropyltri methoxysilane, 3-aminopropylmethyl-di-ethoxysilane,3-aminopropyltri ethoxysilane, poly(dimethylsiloxane)-aminopropyl-dimethylterminated, aminofunctionalsiloxane copolymers containing aminomethyl, aminoethyl, aminopropylmethyl, aminobutyl; aminoethylaminopropylmethylsiloxane-di methylsiloxane copolymers, aminoethylaminoisobutylmethylsiloxane-di methylsiloxane copolymers, and aminoethylaminopropylmethoxysiloxane-di methylsiloxane copolymers. The aminated polysiloxane solution is prepared in a water immiscible solvent selected from the group consisting of chlorinated solvents, aromatic or aliphatic hydrocarbons and water saturated higher alcohols. The concentration of the aminated polysiloxane is in the range of 0.2% to 50%.

The aminated polysiloxane coated membrane is heated at 30° C. to 100° C. for 10 seconds to 6 hours by either keeping in an oven or by drying with running hot air or by any other convenient method. Crosslinking of the aminated polysiloxane coated on porous support membrane is effected by dipping it into an aqueous dialdehyde solution for 2 seconds to 4 hours.

The aliphatic dialdehyde has the following structure 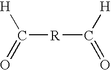
Where R=CₙHₘ; n=0-8; m=0-16

The dialdehyde treated membrane is heated at 30° C. to 100° C. for 10 seconds to 6 hours by either keeping in an oven or by drying with running hot air or by any other convenient method. The concentration of aqueous dialdehyde solution used for crosslinking in interfacial manner is in the range of 0.1% v/v to 25% v/v.

In a feature of the present invention, thin film composite membranes are prepared by coating aminated polysiloxanes solution in appropriate solvent by dip coating, spray coating or any other method on the surface of the porous support membrane. In another feature, the porous support membrane is in the form of flat sheet, tubular or hollow fiber. In another feature, the flat sheet porous support membrane of varying porosity can be prepared on the top of woven or non-woven fabric by conventional methods. In still another feature, the coating of aminated polysiloxane can be done on one side or on both sides of the porous support membrane or can be impregnated inside the pores.

The following examples describe the process of the invention and are illustrative and should not be construed to limit the scope of the present invention in any manner.

### EXAMPLE-1

A solution was prepared by adding 34 g of zinc chloride in 816 g of dry N,N-dimethyl formamide (DMF) while stirring for 16 hours at ambient temperature. A 150 g of polyacrylonitrile was added slowly and stirred for 72 hours using a mechanical stirrer at ambient temperature. The formed dope solution was degassed and centrifuged. The membrane was prepared by casting the dope solution on a running non-woven polyester fabric followed by precipitation in water at 20° C. and then washed under running water. The formed membrane has water flux of 106 1.m⁻².h⁻¹, rejection of bovine serum albumin of 97% and bubble point of>3.6 bar. The formed membrane was used as the support for making thin film composite membranes as explained in following examples.

### EXAMPLE-2

A solution was prepared by adding 33.2 g of zinc chloride in 796.8 g of dry N,N-dimethyl formamide (DMF) while stirring for 16 hours at ambient temperature. A 170 g of polyacrylonitrile was added slowly and stirred for 72 hours, using a mechanical stirrer at ambient temperature. The formed dope solution was degassed and centrifuged. The membrane was prepared by casting the dope solution on a running non-woven polyester fabric followed by precipitation in water at 20° C. and then washed under running water. Thus formed membrane had water flux, rejection of bovine serum albumin and bubble point of 130 1.m⁻².h⁻¹, 100% and >4 bar, respectively. The formed membrane was used as the support for making thin film composite membranes as explained in following examples.

### EXAMPLE-3

A solution was prepared by adding 32 g of zinc chloride in 768 g of dry N,N-dimethyl formamide (DMF) while stirring for 16 hours at ambient temperature. 200 g of polyacrylonitrile was added slowly and stirred for 72 hours, using a mechanical stirrer at ambient temperature. The formed dope solution was degassed and centrifuged. The membrane was prepared by casting the dope solution on a running non-woven polyester fabric followed by precipitation in water at 20° C. and then washed under running water. Thus formed membrane had water flux, rejection of bovine serum albumin and bubble point of 33.5 1.m⁻².h⁻¹, 95% and >4 bar, respectively. The formed membrane was used as the support for making thin film composite membranes as explained in following examples.

### EXAMPLE-4

A solution was prepared by adding 200 g of dry polysulfone in 800 g of dry N,N-dimethyl formamide (DMF) while stirring for 24 hours at ambient temperature. The formed dope solution was degassed and centrifuged. The membrane was prepared by casting the dope solution on a running non-woven polyester fabric followed by precipitation in water at 8° C. and then curing at 60° C. Thus formed membrane had water flux, rejection performance of bovine serum albumin and bubble point of 24 1.m⁻².h⁻¹, 98% and >4 bar, respectively. The formed membrane was used as the support for making thin film composite membranes as explained in following examples.

### EXAMPLE-5

A polyacrylonitrile membrane as prepared in EXAMPLE-1 was treated by keeping in isopropyl alcohol for 24 hours and then in hexane for 24 hours. It was air dried for 120 seconds and then dipped in 4% w/v hexane solution of aminomethylpolysiloxane having the amine value of 30 mg KOH/gm for 2 minutes. The membrane was held in open atmosphere for 90 seconds and then dipped in 2% v/v aqueous glutaraldehyde solution for 80 minutes. This was followed by drying the membrane in open air for 3 minute and then in oven at 80° C. for 90 minutes. The gas permeance of this membrane for various gases expressed in cm³(STP)/(cm².s.cmHg) is as given in TABLE-1.

TABLE 1

| Helium | Hydrogen | Nitrogen | Oxygen | Carbon dioxide |
|---|---|---|---|---|
| 3.8 × 10⁻⁴ | 6.89 × 10⁻⁴ | 2.68 × 10⁻⁴ | 5.17 × 10⁻⁴ | 2.08 × 10⁻³ |

### EXAMPLE-6

A polyacrylonitrile membrane as prepared in EXAMPLE-1 was treated by keeping in isopropyl alcohol for 48 hours and then in hexane for 48 hours. It was air dried for 180 seconds and then dipped in 4% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-2.

TABLE 2

| Helium | Hydrogen | Nitrogen | Oxygen | Carbon dioxide |
|---|---|---|---|---|
| 4.09 × 10⁻⁴ | 7.16 × 10⁻⁴ | 2.83 × 10⁻⁴ | 5.39 × 10⁻⁴ | 2.21 × 10⁻³ |

### EXAMPLE-7

A polyacrylonitrile membrane as prepared in EXAMPLE-2 was treated by keeping in isopropyl alcohol for 36 hours and then in hexane for 36 hours. It was air dried for 150 seconds and then dipped in 4% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 80 minutes. This was followed by drying the membrane in open air for 3 minute and then in oven at 80° C. for 90 minutes. The gas permeance of this membrane for various gases expressed in cm³(STP)/(cm².s.cmHg) is as given in TABLE-3.

TABLE 3

| Helium | Hydrogen | Nitrogen | Oxygen | Carbon dioxide | Methane |
|---|---|---|---|---|---|
| 2.09 × 10⁻⁴ | 3.72 × 10⁻⁴ | 1.52 × 10⁻⁴ | 3.24 × 10⁻⁴ | 1.65 × 10⁻³ | 4.74 × 10⁻⁴ |

### EXAMPLE-8

A polyacrylonitrile membrane as prepared in EXAMPLE-2 was treated by keeping in isopropyl alcohol for 24 hours and then in hexane for 24 hours. It was air dried for 120 seconds and then dipped in 4% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-4.

TABLE 4

| Helium | Hydrogen | Nitrogen | Oxygen | Carbon dioxide | Methane |
|---|---|---|---|---|---|
| 2.35 × 10⁻⁴ | 4.22 × 10⁻⁴ | 1.72 × 10⁻⁴ | 3.66 × 10⁻⁴ | 1.85 × 10⁻³ | 4.97 × 10⁻⁴ |

### EXAMPLE-9

A polyacrylonitrile membrane as prepared in EXAMPLE-2 was treated by keeping in isopropyl alcohol for 24 hours and then in hexane for 24 hours. It was air dried for 120 seconds and then dipped in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-5.

TABLE 5

| Helium | Hydrogen | Nitrogen | Oxygen | Carbon dioxide |
|---|---|---|---|---|
| 4.84 × 10⁻⁴ | 8.49 × 10⁻⁴ | 3.35 × 10⁻⁴ | 6.74 × 10⁻⁴ | 3.05 × 10⁻³ |

### EXAMPLE-10

A polyacrylonitrile membrane as prepared in EXAMPLE-2 was treated by keeping in isopropyl alcohol for 36 hours and then in hexane for 36 hours. It was air dried for 150 seconds and then dipped in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 20 minutes. This was followed by drying the membrane in open air for 1 minute and then in oven at 70° C. for 45 minutes. The gas permeance of this membrane for various gases expressed in cm³(STP)/(cm².s.cmHg) is as given in TABLE-6.

TABLE 6

| Helium | Hydrogen | Nitrogen | Oxygen | Carbon dioxide |
|---|---|---|---|---|
| 5 × 10⁻⁴ | 8.69 × 10⁻⁴ | 3.3 × 10⁻⁴ | 6.44 × 10⁻⁴ | 3.05 × 10⁻³ |

### EXAMPLE-11

A polyacrylonitrile membrane as prepared in EXAMPLE-2 was treated by keeping in isopropyl alcohol for 48 hours and then in hexane for 48 hours. It was air dried for 180 seconds and then dipped in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 10 minutes. This was followed by drying the membrane in open air for 1 minute and then in oven at 70° C. for 45 minutes. The gas permeance of this membrane for various gases expressed in cm³(STP)/(cm².s.cmHg) is as given in TABLE-7.

TABLE 7

| Helium | Hydrogen | Nitrogen | Oxygen | Carbon dioxide |
|---|---|---|---|---|
| 7.03 × 10⁻⁴ | 1.22 × 10⁻³ | 4.64 × 10⁻⁴ | 8.74 × 10⁻⁴ | 3.59 × 10⁻³ |

### EXAMPLE-12

A polyacrylonitrile membrane as prepared in EXAMPLE-2 was treated by keeping in isopropyl alcohol for 48 hours and then in hexane for 48 hours. It was air dried for 180 seconds and then dipped in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 2 minutes. This was followed by drying the membrane in open air for 1 minute and then in oven at 70° C. for 45 minutes. The gas permeance of this membrane for various gases expressed in cm³(STP)/(cm².s.cmHg) is as given in TABLE-8.

TABLE 8

| Helium | Hydrogen | Nitrogen | Oxygen | Carbon dioxide |
|---|---|---|---|---|
| 1.28 × 10⁻³ | 2.02 × 10⁻³ | 9.36 × 10⁻⁴ | 1.21 × 10⁻³ | 4.00 × 10⁻³ |

### EXAMPLE-13

A polyacrylonitrile membrane as prepared in EXAMPLE-2 was treated by keeping in isopropyl alcohol for 24 hours and then in hexane for 24 hours. It was air dried for 120 seconds and then dipped in a 1% w/v hexane solution of aminomethylpolysiloxane having a amine value of 30 mg KOH/gm for 2 minutes. The membrane was held in open atmosphere for 40 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-9.

TABLE 9

| Helium | Hydrogen | Nitrogen | Oxygen | Carbon dioxide |
|---|---|---|---|---|
| 5.6 × 10⁻⁴ | 9.84 × 10⁻⁴ | 3.96 × 10⁻⁴ | 8.06 × 10⁻⁴ | 3.71 × 10⁻³ |

### EXAMPLE-14

A polyacrylonitrile membrane as prepared in EXAMPLE-2 was treated by keeping in isopropyl alcohol for 12 hours and then in hexane for 12 hours. It was air dried for 90 seconds and then dipped in a 0.5% w/v hexane solution of aminomethylpolysiloxane having a amine value of 30 mg KOH/gm for 2 minutes. The membrane was held in open atmosphere for 40 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-10.

TABLE 10

| Helium | Hydrogen | Nitrogen | Oxygen | Carbon dioxide |
|---|---|---|---|---|
| 6.71 × 10⁻⁴ | 1.12 × 10⁻³ | 4.31 × 10⁻⁴ | 7.95 × 10⁻⁴ | 2.66 × 10⁻³ |

### EXAMPLE-15

A polyacrylonitrile membrane as prepared in EXAMPLE-3 was treated by keeping in isopropyl alcohol for 36 hours and then in hexane for 36 hours. It was air dried for 150 seconds and then dipped in a 4% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 80 minutes. This was followed by drying the membrane in open air for 3 minute and then in oven at 80° C. for 90 minutes. The gas permeance of this membrane for various gases expressed in cm³(STP)/(cm².s.cmHg) is as given in TABLE-11.

TABLE 11

| Helium | Hydrogen | Nitrogen | Oxygen | Carbon dioxide |
|---|---|---|---|---|
| 1.82 × 10⁻⁴ | 3.04 × 10⁻⁴ | 1.17 × 10⁻⁴ | 2.36 × 10⁻⁴ | 9.98 × 10⁻⁴ |

### EXAMPLE-16

A polyacrylonitrile membrane as prepared in EXAMPLE-3 was treated by keeping in isopropyl alcohol for 30 hours and then in hexane for 30 hours. It was air dried for 130

seconds and then dipped in a 4% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-12.

TABLE 12

| Helium | Hydrogen | Nitrogen | Oxygen | Carbon dioxide |
|---|---|---|---|---|
| 1.99 × 10⁻⁴ | 3.48 × 10⁻⁴ | 1.46 × 10⁻⁴ | 3.06 × 10⁻⁴ | 1.43 × 10⁻³ |

### EXAMPLE-17

A polyacrylonitrile membrane as prepared in EXAMPLE-3 was treated by keeping in isopropyl alcohol for 24 hours and then in hexane for 24 hours. It was air dried for 120 seconds and then dipped in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-13.

TABLE 13

| Helium | Hydrogen | Nitrogen | Oxygen | Carbon dioxide |
|---|---|---|---|---|
| 1.7 × 10⁻⁴ | 3.25 × 10⁻⁴ | 1.18 × 10⁻⁴ | 2.33 × 10⁻⁴ | 1.06 × 10⁻³ |

### EXAMPLE-18

A polyacrylonitrile membrane as prepared in EXAMPLE-3 was treated by keeping in isopropyl alcohol for 24 hours and then in hexane for 24 hours. It was air dried for 120 seconds and then dipped in a 1% w/v hexane solution of aminomethylpolysiloxane having an amine value of 30 mg KOH/gm for 2 minutes. The membrane was held in open atmosphere for 40 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-14.

TABLE 14

| Helium | Hydrogen | Nitrogen | Oxygen | Carbon dioxide |
|---|---|---|---|---|
| 5.26 × 10⁻⁴ | 9.02 × 10⁻⁴ | 3.5 × 10⁻⁴ | 6.77 × 10⁻⁴ | 2.88 × 10⁻³ |

### EXAMPLE-19

A polyacrylonitrile membrane as prepared in EXAMPLE-3 was treated by keeping in isopropyl alcohol for 12 hours and then in hexane for 12 hours. It was air dried for 180 seconds and then dipped in a 0.5% w/v hexane solution of aminomethylpolysiloxane having an amine value of 30 mg KOH/gm for 2 minutes. The membrane was held in open atmosphere for 40 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-15.

TABLE 15

| Helium | Hydrogen | Nitrogen | Oxygen | Carbon dioxide |
|---|---|---|---|---|
| 4.92 × 10⁻⁴ | 7.95 × 10⁻⁴ | 2.88 × 10⁻⁴ | 5.17 × 10⁻⁴ | 1.86 × 10⁻³ |

### EXAMPLE-20

A polysulfone membrane as prepared in EXAMPLE-4 is dried at 60° C. in an oven for 15 minutes after which it is allowed to come to room temperature and subsequently dipped in hexane for 3 minutes, followed by dipping in a 6% w/v hexane solution of aminomethylpolysiloxane having an amine value of 30 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-16.

TABLE 16

| Helium | Hydrogen | Nitrogen | Oxygen | Carbon dioxide |
|---|---|---|---|---|
| 1.04 × 10⁻⁴ | 1.64 × 10⁻⁴ | 5.06 × 10⁻⁵ | 8.96 × 10⁻⁵ | 3.05 × 10⁻⁴ |

### EXAMPLE-21

A polysulfone membrane as prepared in EXAMPLE-4 is dried at 60° C. in an oven for 20 minutes after which it is allowed to come to room temperature and subsequently dipped in hexane for 3 minutes, followed by dipping in a 4% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-17.

TABLE 17

| Helium | Nitrogen | Oxygen | Carbon dioxide |
|---|---|---|---|
| 1.21 × 10⁻⁴ | 7.13 × 10⁻⁵ | 1.44 × 10⁻⁴ | 5.71 × 10⁻⁴ |

### EXAMPLE-22

A polysulfone membrane as prepared in EXAMPLE-4 is dried at 60° C. in a oven for 10 minutes after which it is allowed to come to room temperature and subsequently dipped in hexane for 3 minutes, followed by dipping in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s. cmHg) is as given in TABLE-18.

TABLE 18

| Helium | Hydrogen | Nitrogen | Oxygen | Carbon dioxide |
|---|---|---|---|---|
| 5.7 × 10⁻⁴ | 8.69 × 10⁻⁴ | 2.97 × 10⁻⁴ | 3.09 × 10⁻⁴ | 4.64 × 10⁻⁴ |

### EXAMPLE-23

A polysulfone membrane as prepared in EXAMPLE-4 is dried at 60° C. in a oven for 15 minutes after which it is allowed to come to room temperature and subsequently dipped in hexane for 3 minutes, followed by dipping in a 2% w/v hexane solution of aminomethylpolysiloxane having an amine value of 30 mg KOH/gm for 2 minutes. The membrane was held in open atmosphere for 60 seconds and then dipped in 2% v/v aqueous glutaraldehyde solution for 10 minutes. This was followed by drying the membrane in open air for 1 minute and then in oven at 70° C. for 45 minutes. The gas permeance of this membrane for various gases expressed in cm³(STP)/(cm².s.cmHg) is as given in TABLE-19.

TABLE 19

| Helium | Hydrogen | Nitrogen | Oxygen | Carbon dioxide |
|---|---|---|---|---|
| 7.21 × 10⁻⁴ | 1.1 × 10⁻³ | 3.79 × 10⁻⁴ | 4.02 × 10⁻⁴ | 6.24 × 10⁻⁴ |

### EXAMPLE-24

A polysulfone membrane as prepared in EXAMPLE-4 is dried at 60° C. in an oven for 25 minutes after which it is allowed to come to room temperature and subsequently dipped in hexane for 3 minutes, followed by dipping in a 2% w/v hexane solution of aminomethylpolysiloxane having an amine value of 30 mg KOHIgm for 2 minutes. The membrane was held in open atmosphere for 60 seconds and then dipped in 2% v/v aqueous glutaraldehyde solution for 2 minutes. This was followed by drying the membrane in open air for 1 minute and then in oven at 70° C. for 45 minutes. The gas permeance of this membrane for various gases expressed in cm³(STP)/(cm².s.cmHg) is as given in TABLE-20.

TABLE 20

| Helium | Hydrogen | Nitrogen | Oxygen | Carbon dioxide |
|---|---|---|---|---|
| 3.97 × 10⁻⁴ | 6.08 × 10⁻⁴ | 2.22 × 10⁻⁴ | 2.7 × 10⁻⁴ | 5.2 × 10⁻⁴ |

### EXAMPLE-25

A polyacrylonitrile membrane as prepared in EXAMPLE-2 was treated by keeping in isopropyl alcohol for 24 hours and then in hexane for 24 hours. It was air dried for 120 seconds and then dipped in a 2% w/v hexane solution of poly(dimethylsiloxane)bis[[3-[(2-aminoethyl)amino] propyl]-dimethylsilyl]ether in hexane for 2 minutes and held in open atmosphere for 60 seconds. The membrane was then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-21.

TABLE 21

| Helium | Hydrogen | Nitrogen | Oxygen | Carbon dioxide |
|---|---|---|---|---|
| 4 × 10⁻⁴ | 6.85 × 10⁻⁴ | 2.64 × 10⁻⁴ | 5.13 × 10⁻⁴ | 1.89 × 10⁻³ |

### EXAMPLE-26

A polyacrylonitrile membrane as prepared in EXAMPLE-2 was treated by keeping in isopropyl alcohol for 36 hours and then in hexane for 36 hours. It was air dried for 150 seconds and then dipped in a 4% w/v hexane solution of dimethyldiaminopolysiloxane having amine value 50 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-22.

TABLE 22

| Helium | Hydrogen | Nitrogen | Oxygen | Carbon dioxide |
|---|---|---|---|---|
| 1.57 × 10⁻⁴ | 2.70 × 10⁻⁴ | 1.03 × 10⁻⁴ | 1.96 × 10⁻⁴ | 6.74 × 10⁻⁴ |

### EXAMPLE-27

A polyacrylonitrile membrane as prepared in EXAMPLE-2 was treated by keeping in isopropyl alcohol for 24 hours and then in hexane for 24 hours. It was air dried for 120 seconds and then dipped in a 2% w/v hexane solution of dimethyldiaminopolysiloxane having amine value 50 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-23.

TABLE 23

| Helium | Hydrogen | Nitrogen | Oxygen | Carbon dioxide |
|---|---|---|---|---|
| 3.15 × 10⁻⁴ | 5.39 × 10⁻⁴ | 2.04 × 10⁻⁴ | 3.79 × 10⁻⁴ | 1.26 × 10⁻³ |

### EXAMPLE-28

A polyacrylonitrile membrane as prepared in EXAMPLE-3 was treated by keeping in isopropyl alcohol for 36 hours and then in hexane for 36 hours. It was air dried for 150 seconds and then dipped in a 4% w/v hexane solution of dimethyldiaminopolysiloxane having amine value 50 mg KOH/gm for 2 minutes. The membrane was held in open atmosphere for 90 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-24.

TABLE 24

| Helium | Hydrogen | Nitrogen | Oxygen | Carbon dioxide |
|---|---|---|---|---|
| 1.07 × 10⁻⁴ | 1.75 × 10⁻⁴ | 6.4 × 10⁻⁵ | 1.07 × 10⁻⁴ | 3.62 × 10⁻⁴ |

### EXAMPLE-29

A polyacrylonitrile membrane as prepared in EXAMPLE-3 was treated by keeping in isopropyl alcohol for 24 hours and then in hexane for 24 hours. It was air dried for 120 seconds and then dipped in a 2% w/v hexane solution of dimethyldiaminopolysiloxane having amine value 50 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-25.

TABLE 25

| Helium | Hydrogen | Nitrogen | Oxygen | Carbon dioxide |
|---|---|---|---|---|
| 2.05 × 10⁻⁴ | 3.35 × 10⁻⁴ | 1.22 × 10⁻⁴ | 1.95 × 10⁻⁴ | 4.66 × 10⁻⁴ |

### EXAMPLE-30

A polysulfone membrane as prepared in EXAMPLE-4 was treated by keeping in isopropyl alcohol for 12 hours and then in hexane for 12 hours. It was air dried for 90 seconds and then dipped in a 2% w/v hexane solution of dimethyldiaminopolysiloxane having amine value 50 mg KOH/gm for 2 minutes. The membrane was held in open atmosphere for 60 seconds and then dipped in 2% v/v aqueous glutaraldehyde solution for 40 minutes. This was followed by drying the membrane in open air for 2 minute and then in oven at 75° C. for 60 minutes. The gas permeance of this membrane for various gases expressed in cm³(STP)/(cm².s.cmHg) is as given in TABLE-26.

TABLE 26

| Helium | Hydrogen | Nitrogen | Oxygen | Carbon dioxide |
|---|---|---|---|---|
| 1.12 × 10⁻⁴ | 1.75 × 10⁻⁴ | 5.58 × 10⁻⁵ | 1.07 × 10⁻⁴ | 3.53 × 10⁻⁴ |

The main advantages of the present invention are: 1. An easy process for making thin film composite membrane by crosslinking of aminated polysiloxanes is demonstrated using aliphatic dialdehyde like glutaraldehyde as a crosslinker. 2. The dialdehyde used as a crosslinker itself is an aliphatic material and is flexible owing to absence of rigid aromatic or vinyl bonds. Its reactivity is comparatively lower than usually demonstrated crosslinkers such as acid chlorides, acid anhydrides, isocyanate, thiocyanate, sulfonyl chloride, etc. Due to lower reactivity of the dialdehyde, it is possible to have better control on the crosslinking degree. 3. Use of the aliphatic dialdehyde in aqueous solution allows the crosslinking of aminated polysiloxane in an interfacial manner. The aminated silicon rubber can be easily dissolved in convenient organic solvent, which is water immiscible. The reaction between dialdehyde and aminated silicone rubber takes place at the interface. By manipulating factors responsible for interfacial reactions like concentration, time of contact, temperature, etc., the extent of reaction and ultimately the thickness of film can be readily controlled. 4. Use of the dialdehyde as the crosslinker ensures that characteristics flexibility in polysiloxane polymer matrix is not hampered to a great extent since dialdehyde itself is not a rigid crosslinker. 5. By using thin film composite membrane it is possible to obtain a good combination of high flux and the selectivity. 6. A family of aminated polysiloxane can be used as potential membrane materials. 7. A range of ultrafiltration support can be explored for various applications. Thus this invention offers a wide spectrum of membranes with good performance. 8. The use of aminated silicon rubber adds to the advantage of selective transport due to the presence of amine functionality. This could be crucial in some of the membrane-based applications such as recovery of aroma compounds or valuable organic compounds having specific functionalities by methods like pervaporation.

We Claim:

1. A process for preparation of a thin film composite membrane based on aminated polysiloxanes, the process comprising coating a pretreated porous support membrane with a solution of aminated polysiloxane in an organic water immiscible solvent, partially drying the coated membrane and crosslinking the partially dried coated membrane with an aqueous solution of aliphaticdialdehyde to obtain a crosslinked membrane, heating the crosslinked membrane in controlled manner to obtain the thin film composite membrane.

2. A process as claimed in claim 1 wherein the porous support membrane is prepared from a polymer selected from the group consisting of polyacrylonitrile, polysulfone, polyethersulfones, polyetherimides, polyphenylene oxides, polyamides, polycarbonates, polyesters, polyethers, polyimides, polyamidimides and polyvinylidene fluoride.

3. A process as claimed in claim 1 wherein the porous support membrane is pretreated dipping in a solvent selected from the group consisting of alcohol, aliphatic or aromatic hydrocarbons and halogenated hydrocarbons, either only once or sequentially in series of solvents for 10 seconds to 48 hours.

4. A process as claimed in claim 1 wherein the porous support membrane is pretreated by drying in hot air flow or in an oven at 30° C. to 100° C.

5. A process as claimed in claim 1 wherein the aminated polysiloxane is selected from the group consisting of aminomethylpolysiloxane with amine value 5-90 mgKOH/gm, dimethyldiaminopolysiloxane with amine value 5-90 mgKOH/gm, poly(dimethylsiloxane)bis[[3-[(2-aminoethyl)amino]propyl]-dimethylsilyl] ether, poly(dimethylsiloxane)-co-(3-aminopropyl)-methylsiloxane, poly(di methylsiloxane)-bis-(3-aminopropyl)terminated, N-(2-Aminoethyl)-3-aminopropylmethyldimethoxysilane, N-(2-Aminoethyl)-3-aminopropyltri methoxysilane, 3-aminopropylmethyl-di-ethoxysilane, 3-aminopropyltri ethoxysilane, poly(dimethylsiloxane)-aminopropyl-dimethylterminated, aminofunctionalsiloxane copolymers containing aminomethyl, aminoethyl, aminopropylmethyl, aminobutyl; aminoethylaminopropylmethylsiloxane-di methylsiloxane copolymers, aminoethylaminoisobutylmethylsiloxane-di methylsiloxane copolymers, and aminoethylaminopropylmethoxysiloxane-di methylsiloxane copolymers.

6. A process as claimed in claim 1 wherein the aminated polysiloxane solution is prepared in a water immiscible solvent selected from the group consisting of chlorinated solvents, aromatic or aliphatic hydrocarbons and water saturated higher alcohols.

7. A process as claimed in claim 1 wherein the concentration of the aminated polysiloxane is in the range of 0.2% to 50%.

8. A process as claimed in claim 1 wherein the aminated polysiloxane coated membrane is heated at 30° C. to 100° C. for 10 seconds to 6 hours by keeping in an oven or by drying with running hot air.

9. A process as claimed in claim 1 wherein the aminated polysiloxane coated on porous support membrane is crosslinked by dipping it into an aqueous dialdehyde solution for 2 seconds to 4 hours.

10. A process as claimed in claim 1 wherein the aliphatic dialdehyde has the following structure 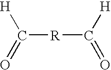
Where R=ₙHₘ;n=0-8;m=0-16

11. A process as claimed in claim 1 wherein the dialdehyde treated membrane is heated at 30° C. to 100° C. for 10 seconds to 6 hours by keeping in an oven or by drying with running hot air.

12. A process as claimed in claim 1 wherein the concentration of aqueous dialdehyde solution used for crosslinking in interfacial manner is in the range of 0.1% v/v to 25% v/v.

13. A process as claimed in claim 1 wherein the aminated polysiloxane solution in appropriate solvent is coated on the surface of the porous support membrane by dip coating or spray coating.

14. A process as claimed in claim 1 wherein the porous support membrane is in the form of flat sheet, tubular or hollow fiber.

15. A process as claimed in claim 1 wherein the flat sheet porous support membrane is converted into a woven or non-woven fabric.

16. A process as claimed in claim 1 wherein the coating of aminated polysiloxane is effected on one side or on both sides of the porous support membrane or is impregnated inside pores of the porous support membrane.
